(19) United States
(12) Patent Application Publication
(10) Pub. No.: US 2008/0004734 A1
(43) Pub. Date: Jan. 3, 2008

(54) MULTIMEDIA PLAYER DEVICE

(75) Inventors: Xiao-Guang Li, Shenzhen City (CN); Kuan-Hong Hsieh, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/769,733

(22) Filed: Jun. 28, 2007

(30) Foreign Application Priority Data
Jun. 30, 2006 (CN) 200610061432.9

(51) Int. Cl. G06F 17/00

(52) U.S. Cl. 700/94

(57) ABSTRACT

An exemplary multimedia player device is provided. The device includes a display, a storage unit, a processing unit, and a plurality of keys. The storage unit is configured for storing multimedia data that includes a playlist and song files. The processing unit is configured for reading the playlist from the storage unit and displaying a subset of the playlist on the display. Each of the plurality of keys corresponds to one of song files listed in the subset of the playlist, and when actuated, signals the multimedia player device to play a corresponding listed song file.

### BACKGROUND

1. Technical Field

The present invention relates to a multimedia player device, and particularly to a multimedia player device capable of quickly obtaining a desired song file in a simple and effective manner.

2. General Background

Most music files, such as, MP3 and WAV, are encoded in a compressed format and hence are small and do not occupy too much memory space. Although the compressed files are lossy, the quality of audio playback is relatively good and acceptable.

As improvements in the manufacturing of semiconductor memory are made, more memory are packed into the portable electronic device. Presently a typical portable electronic device has a built-in memory of tens or hundreds of megabytes (MB). Further, the storage capacity of the portable electronic device could be expanded by installing memory chips or cards. Therefore, the portable electronic device could hold large numbers of compressed music files.

While being in use, the portable electronic device may list a plurality of music files on a display for selection. For music selection among the listed music files, the portable electronic device further provides a plurality of keys for selection operations. Typically, the conventional portable electronic device provides a forward key and a backward key for performing music selection from the listed music files. While there are many music files listed on the display and a desired music file does not appear on the display, the conventional selection manner described above may take up a lot of the user's time because the user must press the forward key or backward key to obtain the desired music file.

What is needed, therefore, is a multimedia player device that provides an improved selection manner, so that the users can quickly and easily obtain the desired music file, and play the desired music file in a simple and effective manner.

### SUMMARY

A multimedia player device is provided. The device includes a display, a storage unit, a processing unit, and a plurality of keys. The storage unit is for storing multimedia data that includes a playlist and song files. The processing unit is connected with the display and the storage unit, and is configured for reading the playlist from the storage unit and displaying a subset of the playlist on the display. Each of the plurality of keys corresponds to one of song files listed in the subset of the playlist, and when actuated, signals the multimedia player device to play a corresponding listed song file.

Other advantages and novel features will be drawn from the following detailed description with reference to the attached drawing.

### BRIEF DESCRIPTION OF THE DRAWINGS

FIG. 1 is a block diagram of a hardware infrastructure of a multimedia player device in accordance with a preferred embodiment of the present invention;

FIG. 2 is a schematic diagram of a front view of the multimedia player device of FIG. 1 in accordance with a preferred embodiment of the present invention;

FIG. 3 illustrates an exemplary display state of the multimedia player device of FIG. 2 when a “MODE” key thereof is actuated while no menu is on the multimedia player device of FIG. 2;

FIG. 4 illustrates an exemplary display state of the multimedia player device of FIG. 3 when no key thereof is actuated; and

FIG. 5 illustrates an exemplary display state of the multimedia player device of FIG. 4 when no key thereof is actuated.

### DETAILED DESCRIPTION OF THE EMBODIMENT

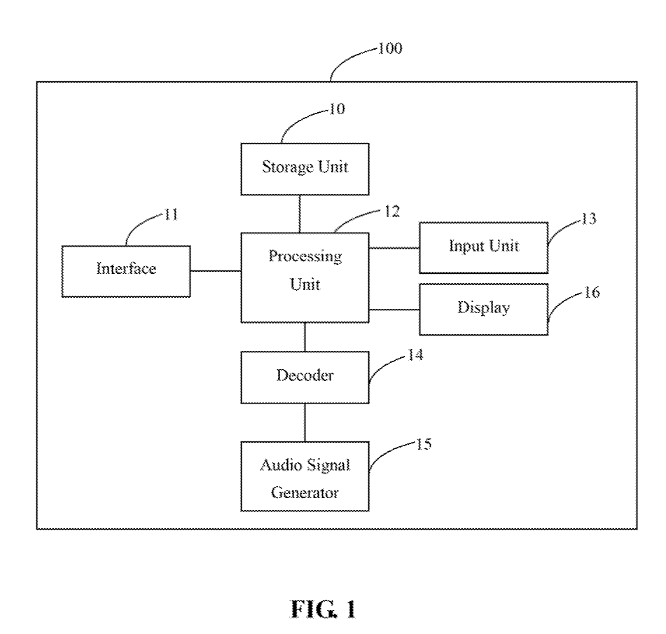

FIG. 1 is a schematic diagram of a hardware infrastructure of a multimedia player device in accordance with a preferred embodiment of the present invention. The multimedia player device 100 includes a storage unit 10, an interface 11, a processing unit 12, an input unit 13, a decoder 14, an audio signal generator 15, and a display 16.

The storage unit 10 is configured for storing multimedia data, such as song files, metadata of each of the song files, and playlists. The metadata of each of the song files includes, song title, song style, play count, artist(s), last play time, and so on. The playlists may include, for example, but not limited to, a first playlist consisting of the song files listed in order according to the play count of the song files, a second playlist consisting of the song files grouped according to the artists of the song files, and a third playlist consisting of the song files played in a recent time period.

The interface 11 is configured for communicating with an external computing system (not shown), for example, such as a personal computer. The decoder 14 is configured for decoding song files fetched from the storage unit 10 and feeding the decoded song files into the audio signal generator 15. The audio signal generator 15 is configured for generating audio signals corresponding to the decoded song files and for outputting the audio signals to an audio output device such as an earphone or speakers (not shown) for listening.

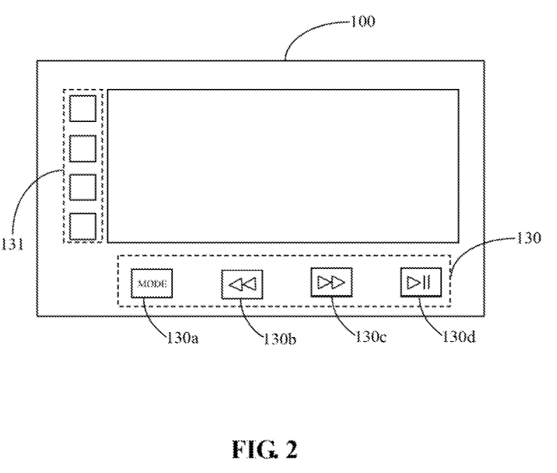

Referring to FIG. 2, the input unit 13 includes a plurality of function keys 130, for example, but not limited to, such as a “MODE” key 130a, a forward key 130c, a backward key 130b, and a play/stop key 130d.

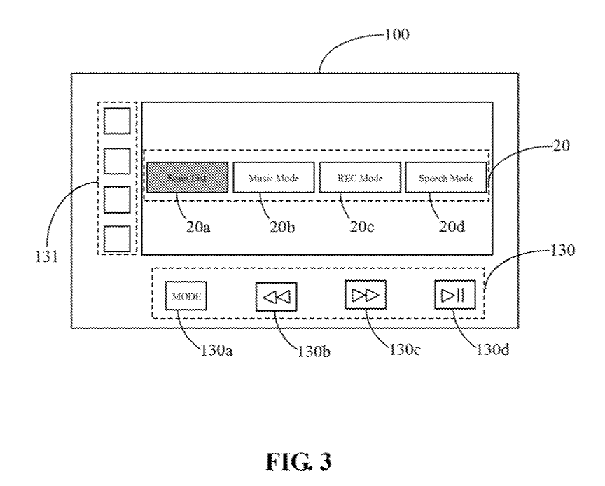

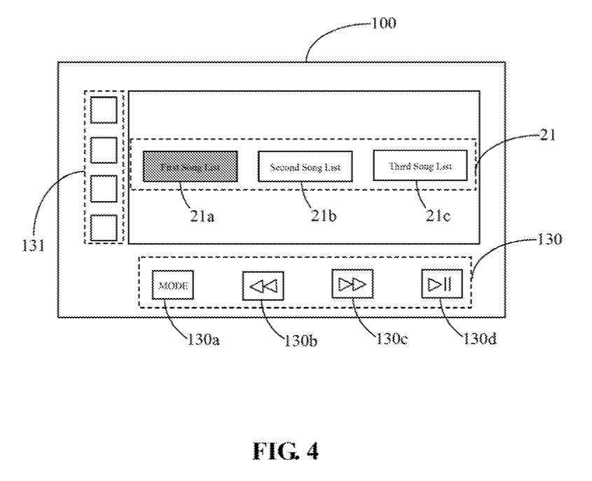

The “MODE” key 130a is configured for signaling the processing unit 12 to display a menu, when actuated. For example, when the “MODE” key 130a is actuated while no menu is on the display 16, the processing unit 12 displays a mode menu 20 on the display 16 (see FIG. 3). The mode menu 20 includes one or more menu options, such as, a playlist option 20a, a music mode option 20b, an REC (Record) mode option 20c, a speech mode option 20d, an FM (Frequency Modulation) mode option (not shown), a system configuration option (not shown), and so on. Each of the menu options may further have a sub-menu 21. For example, with respect to the playlist option 20a, it has the sub-menu 21 (see FIG. 4) consisting of a first playlist option 21a, a second playlist option 21b, and a third playlist option 21c. In order to select the options, the multimedia player device 100 provides the forward key 130c and the backward key 130b for selection.

The mode menu 20 and the sub-menu 21 have a default option selection, which is represented in a darker highlight. For example, in the embodiment as shown in FIG. 3 and FIG. 4, the playlist option 20a is designed as the default option of the mode menu 20, and the first playlist option 21a is designed as the default option of the sub-menu 21. After a period of time (e.g., two seconds) and the forward key 130c or backward key 130b is not selected, while in the mode menu 20 or the sub-menu 21, the default option will be activated.

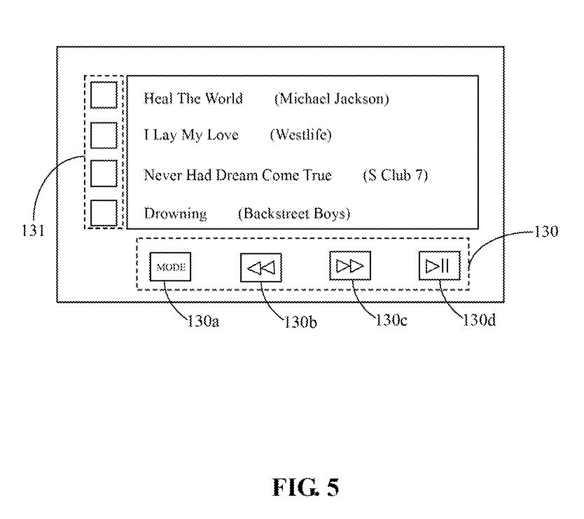

For example, if no selection is made after the set time period and the mode menu 20 is on the display 16, the processing unit 12 expands the sub-menu 21 of the playlist option 20a which contents are displayed as that shown in FIG. 4. If no selection is made after the set time period and the sub-menu 21 is on the display 16, the processing unit 12 executes a function indicated by the first playlist option 21a (i.e., displaying a subset of the first playlist option 21a as that shown in FIG. 5). Accordingly, if a user of the multimedia player device 100 wants to obtain a playlist, he/she can press the ‘“MODE” key 130a for a short time (e.g., two seconds). In other words, the “MODE” key 130a can be regarded as a hot key for obtaining a playlist.

In addition, when the subset of the playlist is on the display 16 such as that shown in FIG. 5 and the “MODE” key 130a is actuated, the processing unit 12 displays a next subset of the playlist on the display 16 in response to the signal generated from the “MODE” key 130a.

Furthermore, corresponding to the song files listed in the displayed subset of the playlist such as that shown in FIG. 5, the multimedia player device 100 provides a plurality of keys 131. The keys 131 adjacent to the listed songs can be pressed to play the corresponding song. The keys 131 are located along an outer peripheral of the display 16, for example, such as that shown in FIG. 5. The number of the keys 131 is the same as a number of the displayed song files.

Therefore, the user of the multimedia player device 100 can readily obtain a desired song file from the displayed song files, without needing to press the backward key 130b or the forward key 130c for selection among the displayed song files. Typically, while there are large numbers of song files on the display 16 and the desired song file does not appears on the display 10, the user of the multimedia player device 100 can effectively and quickly obtain the desired song file through pressing one of the keys 131 corresponding to the displayed desired song file.

In addition, the display 16 can be a non-volatile display, such as an E-Ink (Electronic Ink) display having a property of being able to display information without power. After the subset of the playlist is on the display 16, the processing unit 12 issues a signal to a power management unit (not shown) for power off the E-Ink display 16. The property of the E-Ink display 16 would allow the multimedia player 100 to readily display the song files of the subset of the playlist on the E-Ink display 16 without consuming power.

Although the present invention has been specifically described on the basis of a preferred embodiment thereof, the invention is not to be construed as being limited thereto. Various changes or modifications may be made to the embodiment without departing from the scope and spirit of the invention.

What is claimed is:

1. A multimedia player device, comprising:
a display;
a storage unit for storing multimedia data that comprises a playlist and song files;
a processing unit, connected with the display and storage unit, configured for reading the playlist from the storage unit and displaying a subset of the playlist on the display; and
a plurality of keys, each of which corresponds to one of song files listed in the subset of the playlist, and when each of which is actuated, signals the multimedia player device to play a corresponding listed song file.

2. The multimedia player device according to claim 1, wherein the display is an Electronic Ink (E-Ink) display.

3. The multimedia player device according to claim 2, wherein after the subset of the playlist is on the display, the processing unit issues a signal for power off the E-Ink display.

4. The multimedia player device according to claim 1, further comprising a hot key, when actuated, for signaling the processing unit to display the subset of the playlist on the display.

5. The multimedia player device according to claim 4, wherein the playlist consists of the song files listed in order according to play counts of the song files.

6. The multimedia player device according to claim 4, wherein the playlist consists of the song files grouped according to artists of the song files.

7. The multimedia player device according to claim 4, wherein the playlist consists of the song files played in a recent time period.

8. The multimedia player device according to claim 4, wherein when the hot key is actuated while the subset of the playlist is on the display, the processing unit display a next subset of the playlist on the display.

9. The multimedia player device according to claim 1, wherein the plurality of keys are located along an outer peripheral of the display.
